(19) United States
(12) Patent Application Publication
(10) Pub. No.: US 2022/0166031 A1
(43) Pub. Date: May 26, 2022

(54) SOLID-STATE BIPOLAR BATTERY HAVING THICK ELECTRODES

(71) Applicant: GM GLOBAL TECHNOLOGY OPERATIONS LLC, Detroit, MI (US)

(72) Inventors: Zhe LI, Shanghai (CN); Xiaochao QUE, Shanghai (CN); Haijing LIU, Shanghai (CN); Yong LU, Shanghai (CN); Meiyuan WU, Shanghai (CN); Thomas A. YERSAK, Royal Oak, MI (US); Mei CAI, Bloomfield Hills, MI (US)

(73) Assignee: GM GLOBAL TECHNOLOGY OPERATIONS LLC, Detroit, MI (US)

(21) Appl. No.: 17/522,331

(22) Filed: Nov. 9, 2021

(30) Foreign Application Priority Data
Nov. 24, 2020 (CN) 202011327145.4

(51) Int. Cl. H01M 4/80

(52) U.S. Cl. CPC H01M 4/808; H01M 2004/021

(57) ABSTRACT

The present disclosure provides a solid-state bipolar battery that includes negative and positive electrodes having thicknesses between about 100 μm and about 3000 μm, and a solid-state electrolyte layer disposed between the negative electrode and the positive electrode and having a thickness between about 5 μm and about 100 μm. The first electrode includes a plurality of negative solid-state electroactive particles embedded on or disposed within a first porous material. The second electrode includes plurality of positive solid-state electroactive particles embedded on or disposed within a second porous material that is the same or different from the first porous material. The solid-state bipolar battery includes a first current collector foil disposed on the first porous material, and a second current collector foil disposed on the second porous material. The first and second current collector foils may each have a thickness less than or equal to about 10 μm.

### CROSS-REFERENCE TO RELATED APPLICATIONS

This application claims the benefit and priority of Chinese Application No. 202011327145.4, filed Nov. 24, 2020. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte layer may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which include a solid-state electrolyte layer disposed between solid-state electrodes, the solid-state electrolyte physically separates the solid-state electrodes so that a distinct separator is not required.

Solid-state batteries have advantages over batteries that include a separator and a liquid organic electrolyte. These advantages can include a longer shelf life with lower self-discharge, simpler thermal management, a reduced need for packaging, and the ability to operate within a wider temperature window. For example, solid-state electrolytes are generally non-volatile and non-flammable, so as to allow cells to be cycled under harsher conditions without experiencing diminished potential or thermal runaway, which can potentially occur with the use of liquid electrolytes. However, solid-state batteries generally experience comparatively low power capabilities, for example, as a result of poor electron and ion transport within the electrodes, which may be caused by limited contact, or void spaces, between solid-state active particles and/or solid-state electrolyte particles. Solid-state batteries may also have comparatively thin electrodes with lower active material loadings (e.g., <70 wt. %) resulting in limited energy densities, for example low energy densities (e.g., <190 Wh/Kg). Such results occur because it is often difficult to build a good electron conductive network when the electrode is thick while the amount of solid-state electrolyte that needs to be added to the electrode to obtain sufficient ionic contact is often large. Accordingly, it would be desirable to develop high-performance solid-state battery designs, materials, and methods that improve power capabilities, as well as energy density.

### SUMMARY

This section provides a general summary of the disclosure, and is not a comprehensive disclosure of its full scope or all of its features.

The present disclosure relates to solid-state batteries (SSBs), for example bipolar solid-state batteries, that include a metal foam material, for example as a current collector. Each bipolar solid-state battery includes a plurality of solid-state electroactive material particles and/or solid-state electrolyte particles embedded within pores of a metal foam and one or more current collector foils disposed on or adjacent to one or more surfaces of the metal foam material.

In various aspects, the present disclosure provides a solid-state battery that includes a first electrode having a thickness greater than or equal to about 100 μm to less than or equal to about 3000 μm; a second electrode having a thickness greater than or equal to about 100 μm to less than or equal to about 3000 μm; and a solid-state electrolyte layer disposed between the first electrode and the second electrode. The first electrode includes a plurality of first solid-state electroactive particles. The second electrode includes a plurality of second solid-state electroactive particles and the plurality of second solid-state electroactive particles are embedded on or disposed within a porous material.

In one aspect, the porous material may have a porosity greater than or equal to about 80 vol. % to less than or equal to about 95 vol. %, an average pore size greater than or equal to about 2 μm to less than or equal to about 1000 μm, and a thickness greater than or equal to about 100 μm to less than or equal to about 4000 μm.

In one aspect, the porous material may be a metal foam selected from an aluminum (Al) foam, a nickel (Ni) foam, a copper (Cu) foam, a nickel-chromium (Ni—Cr) foam, a nickel-tin (Ni—Sn) foam, and a titanium (Ti) foam.

In one aspect, the porous material may be one of a carbon nanofiber three-dimensional foam, a graphene foam, a carbon cloth, a carbon fiber-embedded carbon nanotubes, and a graphene-nickel foam.

In one aspect, the porous material may be a first porous material, the first electrode may have a thickness greater than or equal to about 500 μm to less than or equal to about 3000 μm, and the plurality of first solid-state electroactive particles may be embedded on or disposed within a second porous material. The first and second porous materials may be the same or different.

In one aspect, the solid-state electrolyte layer may include a plurality of solid-state electrolyte particles.

In one aspect, the plurality of solid-state electrolyte particles may be a first plurality of solid-state electrolyte particles, the first electrode may further include a second plurality of solid-state electrolyte particles embedded on or disposed within the first porous material with the first plurality of solid-state electroactive particles, and the second electrode may further include a third plurality of solid-state electrolyte particles embedded on or disposed within the second porous material with the second plurality of solid-state electroactive particles. The first, second, and third pluralities of solid-state electrolyte particles may be the same or different.

In one aspect, the solid-state electrolyte layer includes a first sublayer including a first plurality of solid-state electrolyte particles, and a second sublayer including a second plurality of solid-state electrolyte particles. The first and second sublayers may be the same or different.

In one aspect, the solid-state battery further includes a first current collector foil disposed on the first porous material adjacent to the first plurality of solid-state electroactive particles, and a second current collector foil disposed on the second porous material adjacent to the second plurality of solid-state electroactive particles. Each foil may have a thickness greater than or equal to about 2 μm to less than or equal to about 30 μm.

In one aspect, each foil has a thickness less than about 10 μm.

In one aspect, at least one of the first and second current collector foils includes a first half that includes a first material, and a second half that includes a second material. The second half may be substantially parallel with the first half. The first and second materials may be different.

In one aspect, the solid-state electrolyte layer may have a thickness greater than or equal to about 5 μm to less than or equal to about 100 μm.

In one aspect, the solid-state battery is a bipolar battery.

In various other aspects, the present disclosure provides a solid-state battery that includes a negative electrode having a thickness greater than or equal to about 100 μm to less than or equal to about 3000 μm, a positive electrode having a thickness greater than or equal to about 100 μm to less than or equal to about 3000 μm, and a solid-state electrolyte layer disposed between the negative electrode and the positive electrode. The first electrode may include a plurality of negative solid-state electroactive particles embedded on or disposed within a first porous material. The second electrode may include a plurality of positive solid-state electroactive particles embedded on or disposed within a second porous material. The second porous material may be the same or different from the first porous material. The solid-state electrolyte layer may have a thickness greater than or equal to about 5 μm to less than or equal to about 100 μm.

In one aspect, the first and second porous materials may each have a porosity greater than or equal to about 80 vol. % to less than or equal to about 95 vol. %, an average pore size greater than or equal to about 2 μm to less than or equal to about 1000 μm, and a thickness greater than or equal to about 100 μm to less than or equal to about 4000 μm.

In one aspect, the first and second porous materials each include one of an aluminum (Al) foam, a nickel (Ni) foam, a copper (Cu) foam, a nickel-chromium (Ni—Cr) foam, a nickel-tin (Ni—Sn) foam, a titanium (Ti) foam, a carbon nanofiber three-dimensional foam, a graphene foam, a carbon cloth, a carbon fiber-embedded carbon nanotube, and a graphene-nickel foam.

In one aspect, the solid-state electrolyte layer includes a first sublayer including a first plurality of solid-state electrolyte particles, and a second sublayer including a second plurality of solid-state electrolyte particles. The first and second sublayers may be the same or different.

In one aspect, the solid-state battery further includes a first current collector foil disposed on the first porous material adjacent to the negative solid-state electroactive particle, and a second current collector foil disposed on the second porous material adjacent to the positive solid-state electroactive particles. Each foil may have a thickness greater than or equal to about 2 μm to less than or equal to about 30 μm.

In one aspect, at least one of the first and second current collector foils includes a first half including a first material, and a second half including a second material. The second half may be substantially parallel with the first half. The first and second materials may be different.

In one aspect, the solid-state battery is a bipolar battery.

In various aspects, the present disclosure provides a solid-state bipolar battery that includes a negative electrode having a thickness greater than or equal to about 100 μm to less than or equal to about 3000 μm, a positive electrode having a thickness greater than or equal to about 100 μm to less than or equal to about 3000 μm, and a solid-state electrolyte layer including a plurality of solid-state electrolyte particles disposed between the negative electrode and the positive electrode and having a thickness greater than or equal to about 5 μm to less than or equal to about 100 μm. The first electrode includes a plurality of negative solid-state electroactive particles embedded on or disposed within a first porous material. The second electrode includes a plurality of positive solid-state electroactive particles embedded on or disposed within a second porous material. The second porous material may be the same or different from the first porous material. The first and second porous materials may each include one of an aluminum (Al) foam, a nickel (Ni) foam, a copper (Cu) foam, a nickel-chromium (Ni—Cr) foam, a nickel-tin (Ni—Sn) foam, a titanium (Ti) foam, a carbon nanofiber three-dimensional foam, a graphene foam, a carbon cloth, a carbon fiber-embedded carbon nanotube, and a graphene-nickel foam. The solid-state bipolar battery may further include a first current collector foil disposed on the first porous material adjacent to the negative solid-state electroactive particles, and a second current collector foil disposed on the second porous material adjacent to the positive solid-state electroactive particles. The first and second current collector foils may each have a thickness less than or equal to about 10 μm.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example solid-state battery including a metal foam in accordance with various aspects of the current technology;

FIG. 2 is a spectroscopy image of the metal foam;

FIG. 3 is an illustration of another example solid-state battery including a metal foam and having a dual-layered solid-state electrolyte in accordance with various aspects of the current technology;

FIG. 4A is an illustration of an example bipolar solid-state battery including a metal foam in accordance with various aspects of the current technology;

FIG. 4B is an illustration of an example bipolar solid-state battery including a metal foam and a dual-layered current collector in accordance with various aspects of the current technology; and

FIG. 5 is an illustration of an example solid-state battery including a partial metal foam in accordance with various aspects of the current technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs), for example bipolar solid-state batteries, that include a metal foam material, for example as a current collector. Each bipolar solid-state battery includes a plurality of solid-state electroactive material particles and/or solid-state electrolyte particles embedded within pores of a metal foam and one or more current collector foils disposed on or adjacent to one or more surfaces of the metal foam material.

Solid-state batteries may have a bipolar stacking design comprising a plurality of bipolar electrodes where a first mixture of solid-state electroactive material particles (and optional solid-state electrolyte particles) is disposed on a first side of a current collector film, and a second mixture of solid-state electroactive material particles (and optional solid-state electrolyte particles) is disposed on a second side of a current collector film that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

Such bipolar solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

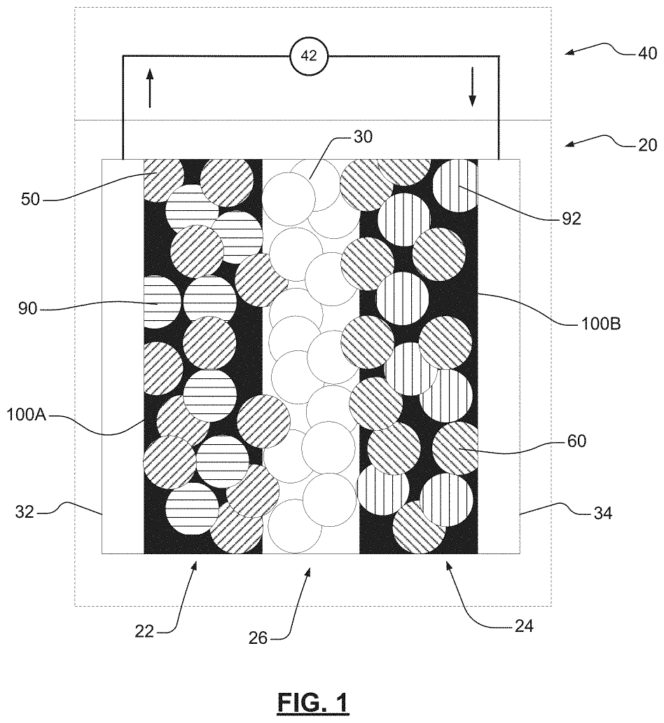

An exemplary and schematic illustration of an all-solid-state electrochemical cell unit (also referred to as “the solid-state battery”, “the solid-state battery cell unit”, “the battery cell unit”, and/or “the battery”) 20 that cycles lithium ions is shown in FIG. 1. The battery 20 includes a negative electrode (i.e., anode) 22, positive electrode (i.e., cathode) 24, and a solid-state electrolyte layer 26. The negative electrode 22 and the positive electrode 24 are each disposed on or embedded within a porous material 100A, 100B (e.g., metal foam), respectively.

Though the illustrated example includes a single positive electrode (i.e., cathode) 24 and a single negative electrode (i.e., anode) 22, the skilled artisan will recognize that the current teachings apply to various other configurations, including those having one or more cathodes and one or more anodes, as well as various current collectors (i.e., metal foam) and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the solid-state electrolyte 26 layer.

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode. The chemical potential difference between the negative electrode 22 and the positive electrode 24 drives electrons produced by a reaction, for example, the oxidation of intercalated lithium, at the negative electrode 22 through the external circuit 40 towards the positive electrode 24. Lithium ions, which are also produced at the negative electrode 22, are concurrently transferred through the solid-state electrolyte layer 26 towards the positive electrode 24. The electrons flow through the external circuit 40 and the lithium ions migrate across the solid-state electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back toward the negative electrode 22 through the external circuit 40, and the lithium ions, which move across the solid-state electrolyte 26 back toward the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected, for example in series, with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the solid-state electrolyte layer 26 acts as a separator that physically separates the negative electrode 22 from the positive electrode 24. The solid-state electrolyte layer 26 may be composed of a first plurality of solid-state electrolyte particles 30. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, to form a continuous electrolyte network, which may be a continuous lithium-ion conduction network. For example, the negative solid-state electroactive particles 50 and the positive solid-state electroactive particles 60 are independently mixed with the second/third plurality of solid-state electrolyte particles 90, 92.

The negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. For example, the negative electrode 22 may include greater than or equal to about 30 wt. % to less than or equal to about 98 wt. %, and in certain aspects, optionally greater than or equal to about 50 wt. % to less than or equal to about 80 wt. %, of the negative solid-state electroactive particles 50 and greater than or equal to about 0 wt. % to less than or equal to about 50 wt. %, and in certain aspects, optionally greater than or equal to about 10 wt. % to less than or equal to about 30 wt. %, of the second plurality of solid-state electrolyte particles 90.

The second plurality of solid-state electrolyte particles 90 may be the same as or different from the first plurality of solid-state electrolyte particles 30. In certain variations, the negative electrode 22 may be a carbonaceous anode and the negative solid-state electroactive particles 50 may comprise one or more negative electroactive materials such as graphite, graphene, hard carbon, soft carbon, and carbon nanotubes (CNTs). In other variations, the negative solid-state electroactive particles 50 may be lithium-based, for example, a lithium alloy. In still other variations, the negative solid-state electroactive particles 50 may be silicon-based comprising, for example, a silicon alloy and/or silicon-graphite mixture. In still further variations, the negative electrode 22 may comprise one or more negative electroactive materials, such as lithium titanium oxide (Li₄Ti₅O₁₂); one or more metal oxides, such as TiO₂ and/or V₂O₅; and metal sulfides, such as FeS. Thus, the negative solid-state electroactive particles 50 may be selected from the group including, for example only, lithium, graphite, graphene, hard carbon, soft carbon, carbon nanotubes, silicon, silicon-containing alloys, tin-containing alloys, and combinations thereof.

In certain variations, the negative electrode 22 may further include one or more conductive additives. For example, the negative solid-state electroactive particles 50 (and/or second plurality of solid-state electrolyte particles 90) may be optionally intermingled with one or more electrically conductive materials (not shown) that provide an electron conduction path. The negative electrode 22 may include greater than or equal to about 0 wt. % to less than or equal to about 30 wt. %, and in certain aspects, optionally greater than or equal to about 1 wt. % to less than or equal to about 5 wt. %, of the one or more electrically conductive additives. The negative electrode 22 may be substantially free of insulating polymer binder materials, such as styrene-butadiene rubber (SBR).

Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. In certain aspects, mixtures of the conductive additives materials may be used.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. For example, the positive electrode 24 may include greater than or equal to about 30 wt. % to less than or equal to about 98 wt. %, and in certain aspects, optionally greater than or equal to about 50 wt. % to less than or equal to about 80 wt. %, of the positive solid-state electroactive particles 60 and greater than or equal to about 0 wt. % to less than or equal to about 50 wt. %, and in certain aspects, optionally greater than or equal to about 10 wt. % to less than or equal to about 30 wt. %, of the third plurality of solid-state electrolyte particles 92.

The third plurality of solid-state electrolyte particles 92 may be the same as or different from the first and/or second pluralities of solid-state electrolyte particles 30, 90. In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0≤x≤1 and 0≤y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNiₓMn_{1.5}O₄(where 0≤x≤1). The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries.

In various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium). In still further variations, the positive electrode 24 may be a low-voltage cathode and the positive solid-state electroactive particles 60 may include one or more positive electroactive materials, such as lithiated metal oxide/sulfide (such as LiTiS₂), lithium sulfide, sulfur, and the like.

In certain variations, the positive electrode 24 may further include one or more conductive additives. For example, the positive solid-state electroactive particles 60 (and/or third plurality of solid-state electrolyte particles 92) may be optionally intermingled with one or more electrically conductive materials (not shown) that provide an electron conduction path. The positive electrode 24 may include greater than or equal to about 0 wt. % to less than or equal to about 30 wt. %, and in certain aspects, optionally greater than or equal to about 1 wt. % to less than or equal to about 5 wt. %, of the one or more electrically conductive additives. The positive electrode 24 may be substantially free of insulating polymer binder materials, such as styrene-butadiene rubber (SBR).

Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives materials may be used.

The negative solid-state electroactive particles 50 and/or the second plurality of solid-state electrolyte particles 90 (as well as any additive) may be embedded within a metal foam 100A and/or dispersed within the pores of the metal foam 100A, such that the negative electrode 22 has a thickness (along the x-axis as illustrated in FIG. 1) greater than or equal to about 100 μm to less than or equal to about 3000 μm, and in certain aspects, optionally greater than or equal to about 500 μm to less than or equal to about 2500 μm.

Likewise, the positive solid-state electroactive particles 60 and/or the third plurality of solid-state electrolyte particles 92 (as well as any additive) may be embedded within a metal foam 100B and/or dispersed within the pores of the metal foam 100B such that the positive electrode 24 has a thickness (along the x-axis as illustrated in FIG. 1) greater than or equal to about 100 μm to less than or equal to about 3000 μm, optionally greater than or equal to about 200 μm to less than or equal to about 2000 μm, optionally greater than or equal to about 200 μm to less than or equal to about 1000 μm, and in certain aspects, optionally greater than or equal to about 500 μm to less than or equal to about 1000 μm

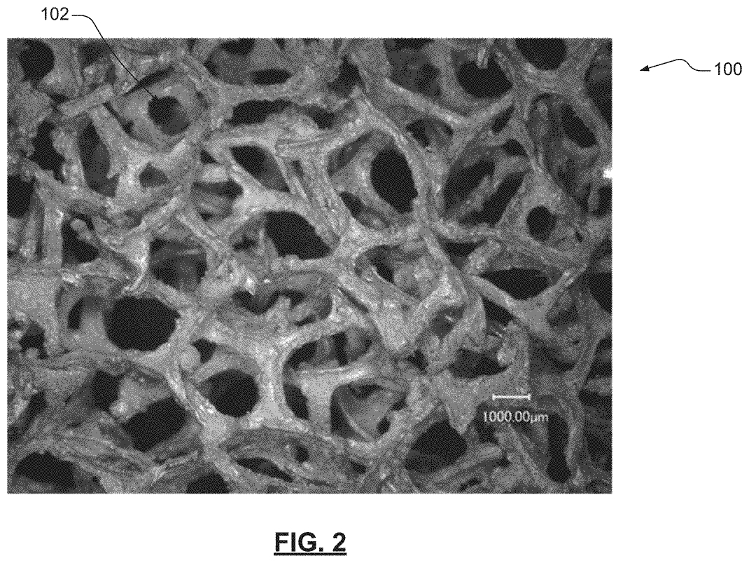

As illustrated in FIG. 2, the metal foams 100A, 100B are porous material (i.e., pores 102) having a porosity greater than or equal to about 80 vol. % to less than or equal to about 99 vol. %, and in certain aspects, optionally greater than or equal to about 80 vol. % to less than or equal to about 95 vol. %. Metal foams 100A, 100B having porosities less than 80 vol. % may negatively affect energy density levels, while metal foams 100A, 100B having porosities greater than 95 vol. % will be fragile, as well as expensive. The pores may have an average diameter greater than or equal to about 2 μm to less than or equal to about 5000 μm, and in certain aspects, optionally greater than or equal to about 100 μm to less than or equal to about 1000 μm.

The metal foams 100A, 100B may be the same or different. Each metal foam 100A, 100B comprises at least one of aluminum (Al) foam, nickel (Ni) foam, copper (Cu) foam, nickel-chromium (Ni—Cr) foam, nickel-tin (Ni—Sn) foam, and titanium (Ti) foam. In certain aspects, the metal foams 100A, 100B may be carbon or graphene coated metal foams. The carbon or graphene coatings may improve the corrosion resistance of the metal foams 100A, 100B. The metal foams 100A, 100B may have thicknesses (along the x-axis) greater than or equal to about 100 μm to less than or equal to about 3000 μm, and in certain aspects, optionally greater than or equal to about 500 μm to less than or equal to about 2500 μm. The metal foams 100A, 100B may provide improved electronic paths and/or a reduced internal resistance within the battery 20 so as to, for example only, reduce resistive losses and promote power capabilities within the battery 20.

Though a metal foam (e.g., metal foam 100A, 100B) is discussed herethroughout it is understood that in each instance the current technology also applies to other porous materials having a porosity greater than or equal to about 80 vol. % to less than or equal to about 99 vol. %, and in certain aspects, optionally greater than or equal to about 80 vol. % to less than or equal to about 95 vol. % and an average diameter greater than or equal to about 2 μm to less than or equal to about 5000 μm, and in certain aspects, optionally greater than or equal to about 100 μm to less than or equal to about 1000 μm, such as carbon nanofiber three-dimensional foam, graphene foam, carbon cloth, carbon fiber-embedded carbon nanotubes, carbon nanotubes three-dimensional current collectors (such as, carbon nanotube paper), graphene-nickel foam, and the like.

A negative electrode current collector foil 32 may be positioned at or near the negative electrode 22. The negative electrode current collector foil 32 may be formed from copper or any other appropriate electrically conductive material known to those of skill in the art. The negative electrode current collector foil 32 may be a foil disposed on a top surface of the metal foam 100A. In such instances, the metal foam 100A provides support to the negative electrode current collector foil 32 such that the negative current collector foil 32 may have a thickness of less than about 10 μm. For example, the negative electrode current collector foil 32 may have a thickness of greater than or equal to about 2 μm to less than or equal to about 30 μm.

Likewise, a positive electrode current collector foil 34 may be positioned at or near the positive electrode 24. The positive electrode current collector foil 34 may be formed from aluminum or any other electrically conductive material known to those of skill in the art. The positive electrode current collector foil 34 may be a foil disposed on a top surface of the metal foam 100B. In such instances, the metal foam 100B provides support to the positive electrode current collector foil 34 such that the positive current collector foil 34 may have a thickness of less than about 10 μm. For example, the positive electrode current collector foil 34 may have a thickness of greater than or equal to about 2 μm to less than or equal to about 30 μm.

The negative electrode current collector foil 32 and the positive electrode current collector foil 34 respectively collect and move free electrons to and from an external circuit 40 (as shown by the block arrows). For example, an interruptible external circuit 40 and a load device 42 may connect the negative electrode 22 (through the negative electrode current collector 32) and the positive electrode 24 (through the positive electrode current collector 34).

With renewed reference to FIG. 1, the solid-state electrolyte layer 26 provides electrical separation—preventing physical contact—between the negative electrode 22 (i.e., an anode) and the positive electrode 24 (i.e., a cathode). In various aspects, the solid-state electrolyte layer 26 may be defined by a first plurality of solid-state electrolyte particles 30 having, for example, an average particle diameter greater than or equal to about 100 nm to less than or equal to about 100 μm. For example, the solid-state electrolyte layer 26 may be in the form of a hot or cold pressed layer or a composite that comprises the first plurality of solid-state electrolyte particles 30, such as a compact inorganic solid-state electrolyte layer. The solid-state electrolyte layer 26 may be in the form of a layer having a thickness (along the x-axis) greater than or equal to about 5 μm to less than or equal to about 100 μm, and in certain aspects, optionally about 30 μm. In certain variations, the solid-state electrolyte particles 30 may have an average diameter that is about 25% of the total average thickness of the solid-state electrolyte 26. The solid-state electrolyte layer 26 may have an interparticle porosity greater than or equal to about 1 vol. % to less than or equal to about 15 vol. %.

The solid-state electrolyte particles 30 may include one or more sulfide-based particles, halide-based particles, hydride-based particles, and the like. In still further variations, the solid-state electrolyte particles 30 may comprise one or more oxide-based particles. In each instance, as would be appreciated by one of ordinary skill in the art, the solid-state electrolyte particles 30 may be wetted by a small amount (for example, greater than or equal to about 5 wt. % to less than or equal to about 20 wt. %) of a liquid electrolyte (e.g. Li₇P₃S₁₁ may be wetted by LiTFSI-Triethylene glycol dimethyl ether, an ionic liquid electrolyte).

In certain variations, the sulfide-based particles may have superionic conductivities (e.g., 10⁻⁴˜10⁻² S/cm). The sulfide-based particles may include pseudobinary sulfides, pseudoternary sulfides, and/or pseudoquaternary sulfides. Pseudobinary sulfides include, for example only, Li₂S—P₂S₅ systems (such as Li₃PS₄, Li₇P₃S₁₁, Li_{9.6}P₃S₁₂), Li₂S—SnS₂ systems (such as Li₄SnS₄), Li₂S—SiS₂ systems, Li₂S—GeS₂ systems, Li₂S—B₂S₃ systems, Li₂S—Ga₂S₃ systems, Li₂S—P₂S₃ systems, and Li₂S—Al₂S₃ systems. Pseudoternary sulfides include, for example only, Li₂O—Li₂S—P₂S₅ systems, Li₂S—P₂S₅—P₂O₅ system, Li₂S—P₂S₅—GeS₂ systems (such as Li_{3.25}Ge_{0.25}P_{0.75}S₄, Li₁₀GeP₂S₁₂), Li₂S—P₂S—P₂S—LiX systems (where X is one of F, Cl, Br, and I) (such as Li₆PS₅Br, Li₆PS₅Cl, Li₇P₂S₈I, Li₄PS₄I), Li2S—As2S5-SnS2 systems (such as Li_{3.833}Sn_{0.833}As_{0.166}S₄), Li₂S—P₂S₅—Al₂S₃ systems, Li₂S—LiX—SiS₂ (where X is one of F, Cl, Br, and I) systems, 0.4LiI.0.6Li₄SnS₄, and Li₁₁Si₂PS₁₂. Pseudoquaternary sulfides include, for example only, Li₂O—Li₂S—P₂S₅—P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂. Solid-state electrolytes, like solid-state electrolyte layer 26, including such sulfide-based particles may be deformable, such that the solid-state electrolyte particles can be consolidated at room temperature without high-temperature sintering processes. Further still, solid-state electrolytes, like solid-state electrolyte layer 26, including such sulfide-based particles may have a superionic conductivity greater than or equal to about 10⁻⁷ S/Cm to less than or equal to about 10⁻² S/cm.

In certain variations, the halide-based particles may include, for example only, Li₃YCl₆, Li₃InCl₆, Li₃YBr₆, LiI, Li₂CdCl₄, Li₂MgCl₄, Li₂CdI₄, Li₂ZnI₄, and Li₃OCl.

In certain variations, the hydride-based particles may include, for example only, LiBH₄, LiBH₄—LiX (where X is one of Cl, Br, and I), LiNH₂, Li₂NH, LiBH₄—LiNH₂, and Li₃AlH₆.

In certain variations, the oxide-based particles may comprise, for example only, one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0<x≤1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The NASICON-type oxides may be defined by LiMM′(PO₄)₃, where M and M′ are independently selected from Al, Ge, Ti, Sn, Hf, Zr, and La. For example, in certain variations, the NASICON-type oxides may be selected from the group consisting of: Li₁₊ₓAlₓGe₂₋ₓ(PO₄)₃ (LAGP) (where 0≤x≤2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), and combinations thereof.

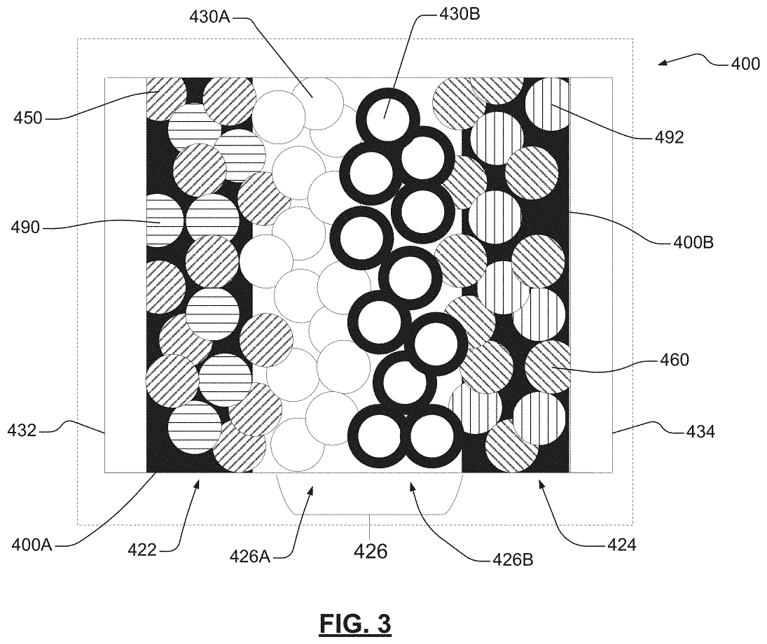

In various aspects, as illustrated in FIG. 3, the present disclosure provides another example solid-state battery 400. The solid-state battery 400 may include a dual-layered solid-state electrolyte 426. The dual-layered solid-state electrolyte 426 may include parallel first and second solid-state electrolyte layers 426A, 426B. For example, as illustrated, the first solid-state electrolyte layer 426A may be adjacent to or near a negative electrode 422, and the second solid-state electrolyte layer 426B may be adjacent to or near a positive electrode 424.

As in the instance of FIG. 1, the negative electrode 422 may be formed from a lithium host material that is capable of functioning as a negative terminal of a lithium-ion battery. For example, in certain variations, the negative electrode 422 may be defined by a plurality of the negative solid-state electroactive particles 450. In certain instances, as illustrated, the negative electrode 422 is a composite comprising a mixture of the negative solid-state electroactive particles 450 and a third plurality of solid-state electrolyte particles 490. Each of the negative solid-state electroactive particles 450 and/or the third plurality of solid-state electrolyte particles 490 may be disposed on or embedded within a metal foam 400A. A negative electrode current collector foil 432 may be positioned at or near the negative electrode 422. The negative electrode current collector foil 432 may be formed from copper or any other appropriate electrically conductive material known to those of skill in the art. The negative electrode current collector foil 432 may be a foil disposed on a top surface of the metal foam 400A.

Likewise, the positive electrode 424 may be formed from a lithium-based or electroactive material that can undergo lithium intercalation and deintercalation while functioning as a positive terminal of a lithium-ion battery. For example, in certain variations, the positive electrode 424 may be defined by a plurality of the positive solid-state electroactive particles 460. In certain instances, as illustrated, the positive electrode 424 is a composite comprising a mixture of the positive solid-state electroactive particles 460 and a fourth plurality of solid-state electrolyte particles 492. Each of the positive solid-state electroactive particles 460 and/or the fourth plurality of solid-state electrolyte particles 492 may be disposed on or embedded within a metal foam 400B. A positive electrode current collector foil 434 may be positioned at or near the positive electrode 424. The positive electrode current collector foil 434 may be formed from aluminum or any other electrically conductive material known to those of skill in the art. The positive electrode current collector foil 434 may be a foil disposed on a top surface of the metal foam 400B.

With renewed reference to FIG. 3, the first solid-state electrolyte layer 426A may be defined by a first plurality of solid-state electrolyte particles 430A. The second solid-state electrolyte layer 426B may be defined by a second plurality of solid-state electrolyte particles 430B. In certain instances, the first and second pluralities of solid-state electrolyte particles 430A, 430B may be the same—that is, the first solid-state electrolyte layer 426A may be the same as (identical to) the second solid-state electrolyte layer 426B. In other instances, the first and second pluralities of solid-state electrolyte particles 430A, 430B may be different. The third plurality of solid-state electrolyte particles 490 and/or the fourth plurality of solid-state electrolyte particles 492 may be the same or different as the first and second pluralities of solid-state electrolyte particles 430A, 430B.

The pluralities of solid-state electrolyte particles 430A, 430B, 490, 492 may include those solid-state electrolyte materials described in the context of FIG. 1. For example, the solid-state electrolyte layers 426A, 426B may be compact inorganic solid-state electrolyte layers. In other instances, the solid-state electrolyte layers 426A, 426B may be hybrid electrolyte layers including an organic component and/or an inorganic component.

The organic component may include one or more polymers and a liquid electrolyte. The one or more polymers may be selected from polyethylene glycol, poly(phenylene oxide) (PPO), poly(methyl methacrylate) (PMMA), polyacrylonitrile (PAN), polyvinylidene fluoride (PVDF), poly(vinylidene fluoride-co-hexafluoropropylene (PVDF-HFP), polyvinyl chloride (PVC), polytetrafluoroethylene (PTFE), carboxymethyl cellulose (CMC), styrene-butadiene (SBR), acrylonitrile butadiene rubber (NBR), poly(styrene-butadiene-styrene) (SBS), and combinations thereof. The liquid electrolyte may be, for example only, one of lithium bis(trifluoromethanesulfonyl)imide (LiTFSI)-triethylene glycol dimethyl ether, lithium hexafluorophosphate (LiPF₆)-ethylene carbonate (EC), diethyl carbonate (DEC) with one or more additives (such as vinylene carbonate (VC), fluoroethylene carbonate, vinyl ethylene carbonate, lithium bis(oxalato) borate), and lithium bis(trifluoromethanesulfonyl)imide (LiTFSI)-acetonitrile.

The inorganic component may include one or more sulfide-based particles, halide-based particles, hydride-based particles, oxide-based particles, and the like, as detailed above. The inorganic component may also include one or more lithium salts, such as lithium bis(trifluoromethanesulfonyl)imide (LiTFSI), lithium hexafluorophosphate (LiPF₆), lithium bis(fluorosulfonyl)imide (LiFSI), and/or lithium tetrafluoroborate (LiBF₄). In still further variations, the inorganic component may include one or more oxide ceramic nanoparticles, such as silicon dioxide (SiO₂), cerium dioxide (CeO₂), aluminum oxide (Al₂O₃), and/or zirconium dioxide (ZrO₂).

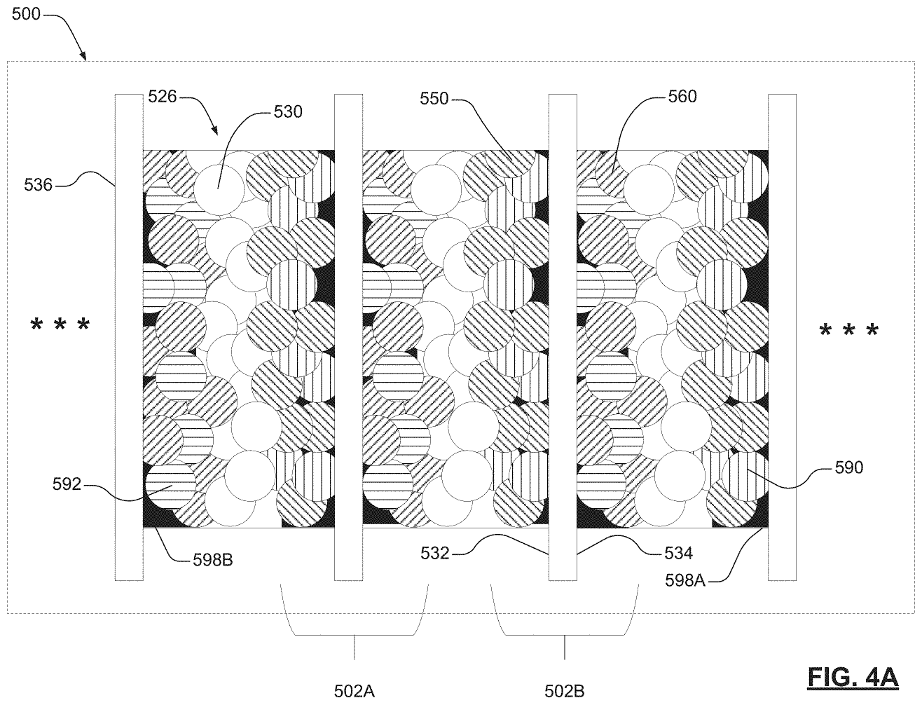

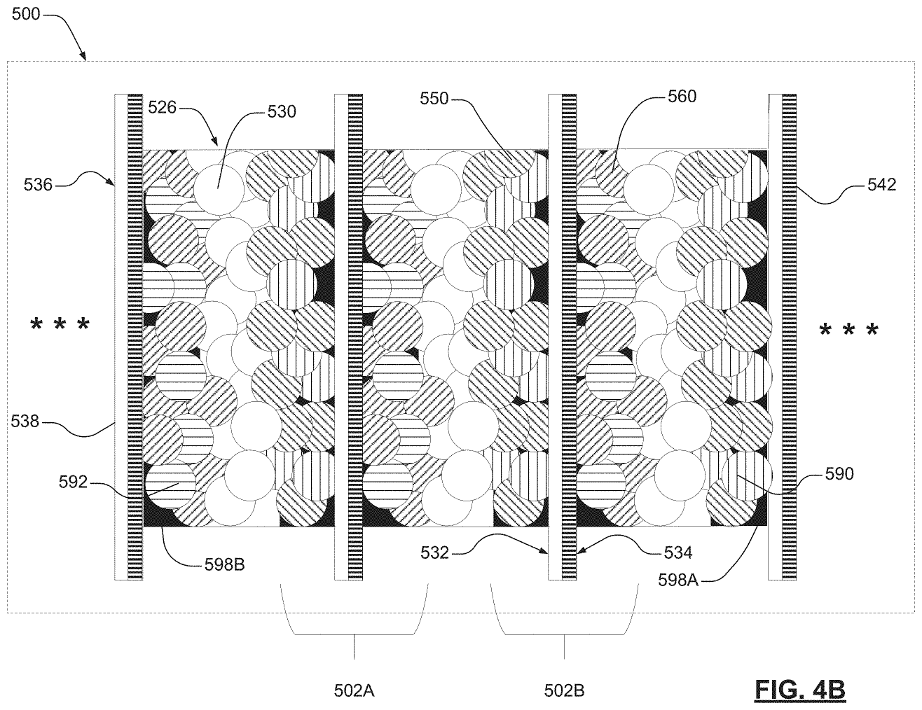

Though the above illustrated examples (FIG. 1 and FIG. 3) include a single positive electrode (i.e., cathode) 24, 424 and a single negative electrode (i.e., anode) 22, 422, the skilled artisan will recognize that the above teachings apply to various other configurations, including those having one or more cathodes and one or more anodes, as well as various current collectors with electroactive particles layers disposed on or adjacent to one or more surfaces thereof. For example, as illustrated in FIGS. 4A-4B, a solid-state battery 500 may include a plurality of electrodes, such as a first bipolar electrode 502A and a second bipolar electrode 502B. The asterisks in FIGS. 4A-4B are meant to illustrate that the battery 500 may include one or more additional electrodes, as would be appreciated by the skilled artisan.

Each of the bipolar electrodes 502A, 502B includes a first plurality of electroactive material particles 550 disposed adjacent to or on a first side or surface 532 of a current collector 536 and a second plurality of electroactive material particles 560 disposed adjacent to or on a second side or surface 534 of the current collector 536. As in the instance of FIG. 1, the first plurality of electroactive material particles 550 and/or second plurality of electroactive material particles 560 may be disposed on or embedded within metal foams 598A, 598B, respectively. The first plurality of electroactive material particles 550 may be negative solid-state electroactive material particles, such as detailed above in the context of negative solid-state electroactive particles 50. The second plurality of electroactive material particles 560 may be positive solid-state electroactive material particles, such as detailed above in the context of positive solid-state electroactive particles 60.

In certain variations, as illustrated, a first plurality of solid-state electrolyte particles 590 may be mixed or intermingled with the first plurality of electroactive material particles 550; and a second plurality of solid-state electrolyte particles 592 may be mixed or intermingled with the second plurality of electroactive material particles 560. A solid-state electrolyte layer 526 may be disposed between consecutive electrodes 502A, 502B. The solid-state electrolyte layer 526 acts as a separator that physically separates the first electrode 502A and the second electrode 502B. The solid-state electrolyte layer 526 may be defined by a third plurality of solid-state electrolyte particles 530. As in the instance of FIG. 1, the first, second, and third pluralities of electrolyte particles 550, 560, 530 may be the same or different. The skilled artisan will also recognize that the solid-state electrolyte layer 526 may be, in certain variations, a dual-layered solid-state electrolyte, such as detailed in the context of FIG. 3.

With renewed reference to FIG. 4A, the current collector foil 536 may be disposed on a (top) surface of the metal foam 598A and/or 598B. The current collector foil 536 may have a thickness greater than or equal to about 2 μm to less than or equal to about 30 μm. The current collector foil 536 may include at least one of stainless steel, aluminum, nickel, iron, titanium, copper, tin, or any other electrically conductive material known to those of skill in the art. In certain variations, the current collector foil 536 may a cladded foil (i.e., where one side (e.g., first side) of the current collector comprises one metal (e.g., first metal) and another side (e.g., second side) of the current collector comprises another metal (e.g., second metal)) including, for example only, aluminum-copper (Al—Cu), nickel-copper (Ni—Cu), stainless steel-copper (SS-Cu), aluminum-copper (Al—Ni), aluminum-stainless steel (Al-SS), and nickel-stainless steel(Ni-SS). In certain variations, the current collector foil 536 may be pre-coated, such as carbon-coated aluminum current collectors.

In other variations, as illustrated in FIG. 4B, the current collector foil 536 may include a first current collector foil 538 and a second current collector foil 542. The first and second current collector foils 538, 542 may be disposed on a (top) surface of the metal foam 598A and/or the metal foam 598B. For example, the first current collector foil 538 may be disposed on a first metal foam 598A, and the second current collector foil 542 may be disposed on a second metal foam 598B. The first current collector foil 538 may define the first side or surface 532 of the current collector 536, and the second current collector 542 may define the second side or surface 534 of the current collector 536. As such, the first current collector foil 538 may be adjacent or near the first plurality of electroactive material particles 550 (first plurality of solid-state electrolyte particles 590) and the second current collector foil 542 may be adjacent or near the second plurality of electroactive material particles 560 (and second plurality of solid-state electrolyte particles 592).

The first current collector foil 538 may be different from the second current collector foil 542. In certain variations, the first current collector foil 538 may be a negative electrode current collector foil and the second current collector foil 542 may be a positive electrode current collector foil. In each instance, the first and second current collector foils 538, 542 may each comprise at least one of stainless steel, aluminum, nickel, iron, titanium, copper, tin, or any other electrically conductive material known to those of skill in the art. The first and second current collectors foils 538, 542 may each have a thickness such that the current collector 536 has a thickness greater than or equal to about 2 μm to less than or equal to about 30 μm.

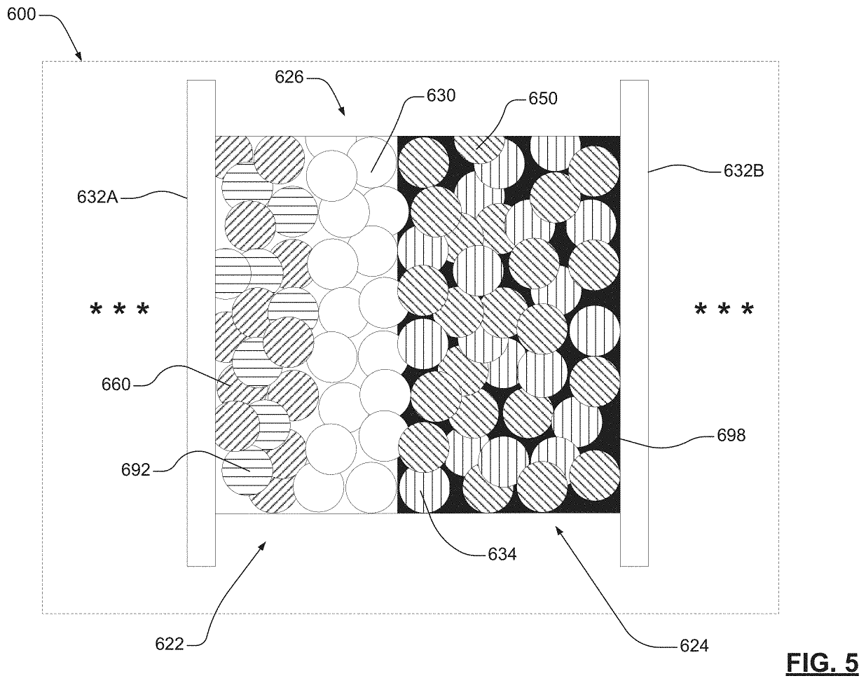

In various aspects, as illustrated in FIG. 5, the present disclosure provides another example solid-state battery 600. The solid-state battery 600 may include a metal foam 698 only in a portion of the battery 600. For example, as illustrated, a positive electrode (i.e., cathode) 624 may include a metal foam 698. The negative electrode (i.e., anode) 622 may be free of a metal foam 698. A solid-state electrolyte layer 626 disposed between the positive electrode 624 and the negative electrode 622 may also be free of the metal foam 698. As in the above described instances, the solid-state electrolyte layer 626 may be defined by a first plurality of solid-state electrolyte particles 630. Though the positive electrode 624 is illustrated as including the metal foam 698, the skill artisan will appreciate that in others instances a positive electrode may be free of a metal foam, while a negative electrode may include the metal foam.

As in the instance of FIG. 1, the negative electrode 622 (without the metal foam) may be formed from a lithium host material that is capable of functioning as a negative terminal of a lithium-ion battery. For example, in certain variations, the negative electrode 622 may be defined by a plurality of the negative solid-state electroactive particles 660. In certain instances, as illustrated, the negative electrode 622 is a composite comprising a mixture of the negative solid-state electroactive particles 660 and a second plurality of solid-state electrolyte particles 692. The negative electrode 622 may have a first thickness of greater than or equal than about 100 μm to less than or equal to about 3000 μm, and in certain instances, optionally greater than or equal to about 500 μm to less than or equal to about 2500 μm.

Likewise, the positive electrode 624 may be formed from a lithium-based or electroactive material that can undergo lithium intercalation and deintercalation while functioning as a positive terminal of a lithium-ion battery. For example, in certain variations, the positive electrode 624 may be defined by a plurality of the positive solid-state electroactive particles 650. In certain instances, as illustrated, the positive electrode 624 is a composite comprising a mixture of the positive solid-state electroactive particles 650 and a third plurality of solid-state electrolyte particles 634. Each of the positive solid-state electroactive particles 650 and/or the third plurality of solid-state electrolyte particles 634 may be disposed on or embedded within a metal foam 698. The positive electrode 624 may have a second thickness that is greater than the first thickness of the negative electrode 622. For example, the positive electrode 624 may have a thickness greater than or equal than about 100 μm to less than or equal to about 2000 μm, and in certain instances, optionally greater than or equal to about 500 μm to less than or equal to about 1500 μm. The metal foam 698 reduces internal resistance and enables the greater thickness of the positive electrode 624.

A current collector foil 632A may be positioned at or near the negative electrode 622. Another current collector foil 632B may be positioned at or near the positive electrode 624. In each instance, the current collector foils 632A, 632B may include at least one of stainless steel, aluminum, nickel, iron, titanium, copper, tin, or any other electrically conductive material known to those of skill in the art. In certain variations, the current collector foils 632A, 632B may include a cladded foil such as, for example only, aluminum-copper (Al—Cu), nickel-copper (Ni—Cu), stainless steel-copper (SS-Cu), aluminum-copper (Al—Ni), aluminum-stainless steel (Al-SS), and nickel-stainless steel(Ni-SS). In certain variations, the current collector foils 632A, 632B may be pre-coated, such as carbon-coated aluminum current collectors.

Certain features of the current technology are further illustrated in the following non-limiting example.

### Example

An example cell is prepared in accordance with various aspects of the present disclosure. For example, the example cell may include a positive electrode (i.e., cathode) comprising about 70 wt. % of NMC622 as the positive solid-state electroactive material. The positive solid-state electroactive material may be disposed on a metal foam having a porosity of about 87 vol. %. The positive electrode may have a thickness of about 1 mm. The example cell may further include a negative electrode (i.e., anode) comprising about 60 wt. % graphite as the negative solid-state electroactive material. The negative solid-state electroactive material may also be disposed on the metal foam. A solid-state electrolyte (SSE) may be disposed between the positive electrode and the negative electrode of the example cell. The solid-state electrolyte may have a thickness of about 30 μm. A first current collector foil may be disposed near or adjacent to the positive electrode, and a second current collector foil may be disposed near or adjacent to the negative electrode. The first and second current collector foils may each have a thickness of about 10 μm.

A comparative cell is also prepared. The comparative cell may include a positive electrode (i.e., cathode) that also comprises about 70 wt. % of NMC622 as the positive solid-state electroactive material. The positive electrode may have a thickness of about 100 μm. The comparative cell may further include a negative electrode (i.e., anode) comprising about 60 wt. % graphite as the negative solid-state electroactive material. The negative electrode may have a thickness of about 123 μm. A solid-state electrolyte (SSE) may be disposed between the positive electrode and the negative electrode of the comparative cell. The solid-state electrolyte may have a thickness of about 30 μm. A first current collector may be disposed near or adjacent to the positive electrode, and a second current collector may be disposed near or adjacent to the negative electrode. The first and second current collector may each have a thickness of about 10 μm.

The example cell may have an energy density of about 203 Wh/kg. The comparative cell may have an energy density of about 211 Wh/kg. The example exhibits a better charge/discharge rate capability due to the sufficient electronic conduction and low resistance within the electrode.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A solid-state battery comprising:
a first electrode having a thickness greater than or equal to about 100 μm to less than or equal to about 3000 μm and comprising a plurality of first solid-state electroactive particles;
a second electrode having a thickness greater than or equal to about 100 μm to less than or equal to about 3000 μm and comprising a plurality of second solid-state electroactive particles, wherein the plurality of second solid-state electroactive particles are embedded on or disposed within a porous material; and
a solid-state electrolyte layer disposed between the first electrode and the second electrode.

2. The solid-state battery of claim 1, wherein the porous material has a porosity greater than or equal to about 80 vol. % to less than or equal to about 95 vol. %, an average pore size greater than or equal to about 2 μm to less than or equal to about 1000 μm, and a thickness greater than or equal to about 100 μm to less than or equal to about 4000 μm.

3. The solid-state battery of claim 1, wherein the porous material is a metal foam selected from an aluminum (Al) foam, a nickel (Ni) foam, a copper (Cu) foam, a nickel-chromium (Ni—Cr) foam, a nickel-tin (Ni—Sn) foam, and a titanium (Ti) foam.

4. The solid-state battery of claim 1, wherein the porous material is one of a carbon nanofiber three-dimensional foam, a graphene foam, a carbon cloth, a carbon fiber-embedded carbon nanotubes, and a graphene-nickel foam.

5. The solid-state battery of claim 1, wherein the porous material is a first porous material, and
wherein the first electrode has a thickness greater than or equal to about 500 μm to less than or equal to about 3000 μm, and the plurality of first solid-state electroactive particles are embedded on or disposed within a second porous material, wherein the first and second porous materials are the same or different.

6. The solid-state battery of claim 5, wherein the solid-state electrolyte layer comprises a plurality of solid-state electrolyte particles.

7. The solid-state battery of claim 6, wherein the plurality of solid-state electrolyte particles is a first plurality of solid-state electrolyte particles,
the first electrode further comprises a second plurality of solid-state electrolyte particles embedded on or disposed within the first porous material with the first plurality of solid-state electroactive particles, and
the second electrode further comprises a third plurality of solid-state electrolyte particles embedded on or disposed within the second porous material with the second plurality of solid-state electroactive particles, wherein the first, second, and third pluralities of solid-state electrolyte particles are the same or different.

8. The solid-state battery of claim 6, wherein the solid-state electrolyte layer comprises:
a first sublayer comprising a first plurality of solid-state electrolyte particles, and
a second sublayer comprising a second plurality of solid-state electrolyte particles, wherein the first and second sublayers are the same or different.

9. The solid-state battery of claim 6, further comprising:
a first current collector foil disposed on the first porous material adjacent to the first plurality of solid-state electroactive particles; and
a second current collector foil disposed on the second porous material adjacent the second plurality of solid-state electroactive particles, wherein each foil has a thickness greater than or equal to about 2 μm to less than or equal to about 30 μm.

10. The solid-state battery of claim 9, wherein each foil has a thickness less than about 10 μm.

11. The solid-state battery of claim 9, wherein at least one of the first and second current collector foils comprises:
a first half comprising a first material, and
a second half comprising a second material, wherein the second half is substantially parallel with the first half, and the first and second materials are different.

12. The solid-state battery of claim 1, wherein the solid-state electrolyte layer has a thickness greater than or equal to about 5 μm to less than or equal to about 100 μm.

13. The solid-state battery of claim 1, wherein the solid-state battery is a bipolar battery.

14. A solid-state battery comprising:
a negative electrode having a thickness greater than or equal to about 100 μm to less than or equal to about 3000 μm and comprising a plurality of negative solid-state electroactive particles embedded on or disposed within a first porous material;
a positive electrode having a thickness greater than or equal to about 100 μm to less than or equal to about 3000 μm and comprising a plurality of positive solid-state electroactive particles embedded on or disposed within a second porous material, wherein the second porous material is the same or different from the first porous material; and
a solid-state electrolyte layer disposed between the negative electrode and the positive electrode, wherein the solid-state electrolyte layer has a thickness greater than or equal to about 5 μm to less than or equal to about 100 μm.

15. The solid-state battery of claim 14, wherein the first and second porous materials each have a porosity greater than or equal to about 80 vol. % to less than or equal to about 95 vol. %, an average pore size greater than or equal to about 2 μm to less than or equal to about 1000 μm, and a thickness greater than or equal to about 100 μm to less than or equal to about 4000 μm.

16. The solid-state battery of claim 14, wherein the first and second porous materials each comprise one of an aluminum (Al) foam, a nickel (Ni) foam, a copper (Cu) foam, a nickel-chromium (Ni—Cr) foam, a nickel-tin (Ni—Sn) foam, a titanium (Ti) foam, a carbon nanofiber three-dimensional foam, a graphene foam, a carbon cloth, a carbon fiber-embedded carbon nanotubes, and a graphene-nickel foam.

17. The solid-state battery of claim 14, wherein the solid-state electrolyte layer comprises:
a first sublayer comprising a first plurality of solid-state electrolyte particles, and
a second sublayer comprising a second plurality of solid-state electrolyte particles, wherein the first and second sublayers are the same or different.

18. The solid-state battery of claim 14, further comprising:
a first current collector foil disposed on the first porous material adjacent to the negative solid-state electroactive particles; and
a second current collector foil disposed on the second porous material adjacent to the positive solid-state electroactive particles, wherein each foil has a thickness greater than or equal to about 2 μm to less than or equal to about 30 μm.

19. The solid-state battery of claim 18, wherein at least one of the first and second current collector foils comprises:
a first half comprising a first material, and
a second half comprising a second material, wherein the second half is substantially parallel with the first half, and the first and second materials different.

20. A solid-state bipolar battery comprising:
a negative electrode having a thickness greater than or equal to about 100 μm to less than or equal to about 3000 μm and comprising a plurality of negative solid-state electroactive particles embedded on or disposed within a first porous material;
a positive electrode having a thickness greater than or equal to about 100 μm to less than or equal to about 3000 μm and comprising a plurality of positive solid-state electroactive particles embedded on or disposed within a second porous material, wherein the second porous material is the same or different from the first porous material and the first and second porous materials each comprise one of an aluminum (Al) foam, a nickel (Ni) foam, a copper (Cu) foam, a nickel-chromium (Ni—Cr) foam, a nickel-tin (Ni—Sn) foam, a titanium (Ti) foam, a carbon nanofiber three-dimensional foam, a graphene foam, a carbon cloth, a carbon fiber-embedded carbon nanotubes, and a graphene-nickel foam;
a solid-state electrolyte layer comprising a plurality of solid-state electrolyte particles disposed between the negative electrode and the positive electrode, wherein the solid-state electrolyte layer has a thickness greater than or equal to about 5 μm to less than or equal to about 100 μm;
a first current collector foil disposed on the first porous material adjacent to the negative solid-state electroactive particles; and
a second current collector foil disposed on the second porous material adjacent to the positive solid-state electroactive particles, wherein the first and second current collector foils each has a thickness less than or equal to about 10 μm.
